(19) United States
(12) Patent Application Publication
(10) Pub. No.: US 2003/0047647 A1
(43) Pub. Date: Mar. 13, 2003

(54) Bulkhead mounted LAN and wireless card distribution point

(76) Inventor: Daniel D. Poblete, Lake Forest, CA (US)

Correspondence Address: HARNESS, DICKEY & PIERCE, P.L.C., P.O. BOX 828, BLOOMFIELD HILLS, MI, 48303, US

(21) Appl. No.: 09/948,896

(22) Filed: Sep. 7, 2001

(51) Int. Cl. B64C 1/20; B64C 1/22; B64D 47/00

(52) U.S. Cl. 244/118.1

(57) ABSTRACT

A device for distributing peripheral devices within an aircraft is disclosed. The device has a front panel which defines a plurality of cavities. Disposed within the cavities are peripheral devices which can be used by an aircraft passenger within the aircraft passenger compartment. Disposed over the cavities is a plurality openable doors which allow access to the peripheral devices. A credit card acceptor in the central processing unit is used to regulate the access to the peripheral devices.

### FIELD OF THE INVENTION

The present invention relates generally to the apparatus for distributing electrical components within an airplane and more particularly pertains to a apparatus for distributing LAN and wireless computer networking cards for use within an aircraft.

### BACKGROUND OF THE INVENTION

With ever increasing demands from airline customers, flexibility and adaptability of aircraft interiors is increasingly required in order to provide an aircraft that meets broader customer needs. Increases in the number of customers serviced and time spent within an aircraft has led customers to constantly request electronic devices, such as computer network access, within an aircraft compartment which allow for activities such as work or play. As such, aircraft manufacturers are constantly updating aircraft passenger compartments with new electronic assemblies.

Frequently, these electronic assemblies are provided within the seat, ceiling, or immediately below the overhead storage compartments of the aircraft. To effectively gain access to these electronic components, passengers must use software, hardware specific cables, and computer peripherals to gain access to the networks.

Several problems exist with the coupling of an individual's computers within an aircraft's computer network. First, an individual's computer hardware must have the software which would allow the coupling of the airline customer's computer to the network. Second, specific hardware is necessary to couple the customer's computer to the aircraft LAN. This hardware, which would very likely only be usable on an aircraft, must be adaptable to any number of passenger computer systems. To date, it would be necessary for flight attendants to help to distribute cabling and peripherals which allow a passenger to connect to the aircraft LAN system.

### SUMMARY OF THE INVENTION

In view of the following disadvantages apparent in the known method of distributing computer peripherals within an aircraft, the present invention provide a bulkhead mounted distribution point to facilitate convenient peripheral distribution for use by passengers within an aircraft passenger compartment. The bulkhead mounted distribution point of the present invention provides software, hardware specific cables, and computer peripherals. The bulkhead mounted distribution point is located adjacent to the aisle between the passenger seats. In addition, a plurality of rotatable or slidable doors are provided to gain access to the peripherals. These doors are openable by using a standard credit card, which is retained by the bulkhead mounted distribution point until the peripheral is returned. As a result, the before mentioned disadvantages associated with the currently available peripheral distribution system have been substantially reduced or eliminated.

### BRIEF DESCRIPTION OF THE DRAWINGS

In the drawings which illustrate the best mode presently contemplated for carrying out the present invention:

FIG. 1 is a perspective view of an aircraft interior showing the peripheral distributor of the present invention;

FIG. 2 is the front view of the peripheral distributor of the present invention;

FIGS. 3a-3c show use of the peripheral distributor to gain access to peripheral devices;

FIG. 4 depicts the use of the peripheral device with a passenger's computer;

FIG. 5 shows the returning of the peripheral device; FIGS. 6a-6c depict an alternate embodiment of the present invention; and

FIG. 7 depicts yet another embodiment of the present invention.

### DETAILED DESCRIPTION OF THE PREFERRED EMBODIMENTS

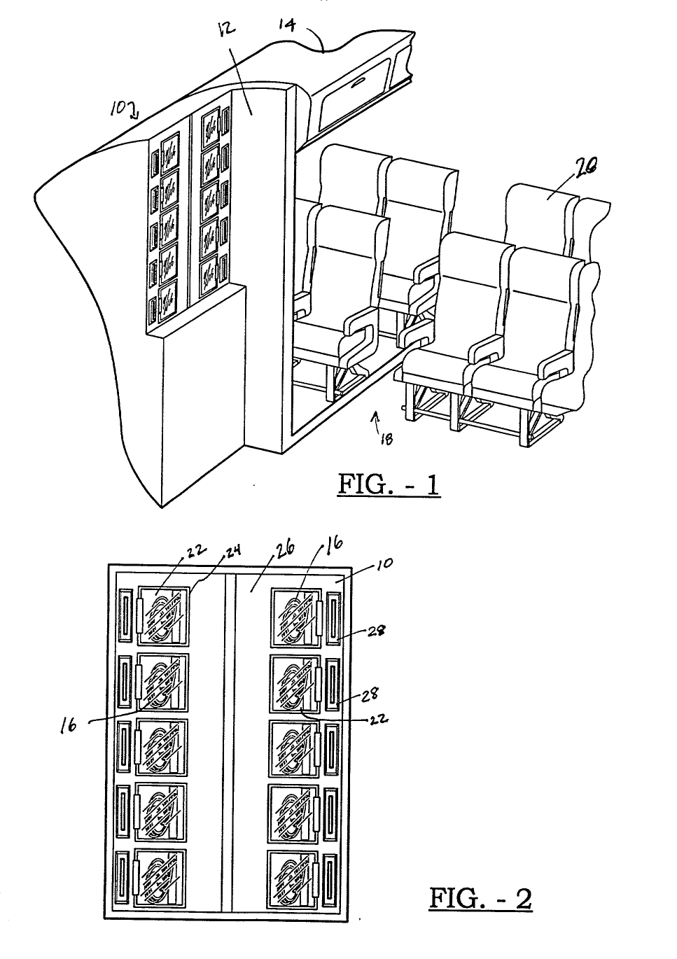

Referring now to the drawings in which like reference numerals designate like or corresponding parts throughout several views, where it is shown in FIG. 1 a peripheral distributor 10 of the present invention located in a bulkhead 12 of an aircraft 14. The bulkhead mounted peripheral distributor 10 can contain one or more peripheral device 16 disposed therein. The peripheral distributor 10 is integrally mounted in a location adjacent an aisle 18 between the aircraft seat 20.

FIG. 2 represents a front view of the peripheral distributor 10. As can be seen, a plurality of peripheral devices 16 are each stored behind individual compartment doors 22. These doors 22 can be hingeably mounted to the peripheral distributor 10 by a hinged 24 or can be slidably mounted within a front panel 26. The peripheral devices 16 can be, but are not limited to, cables, LAN network cards, PCMIA interface cards, storage devices, or displays.

Further shown is a plurality of credit card acceptors 28, which are used to access the peripheral devices 16. The credit card acceptors 28 provide a mechanism for aircraft passengers to rent the peripheral devices 16 during a flight. Optionally, the credit card acceptor 28 can be used to rent time used on an local area network (LAN) 40.

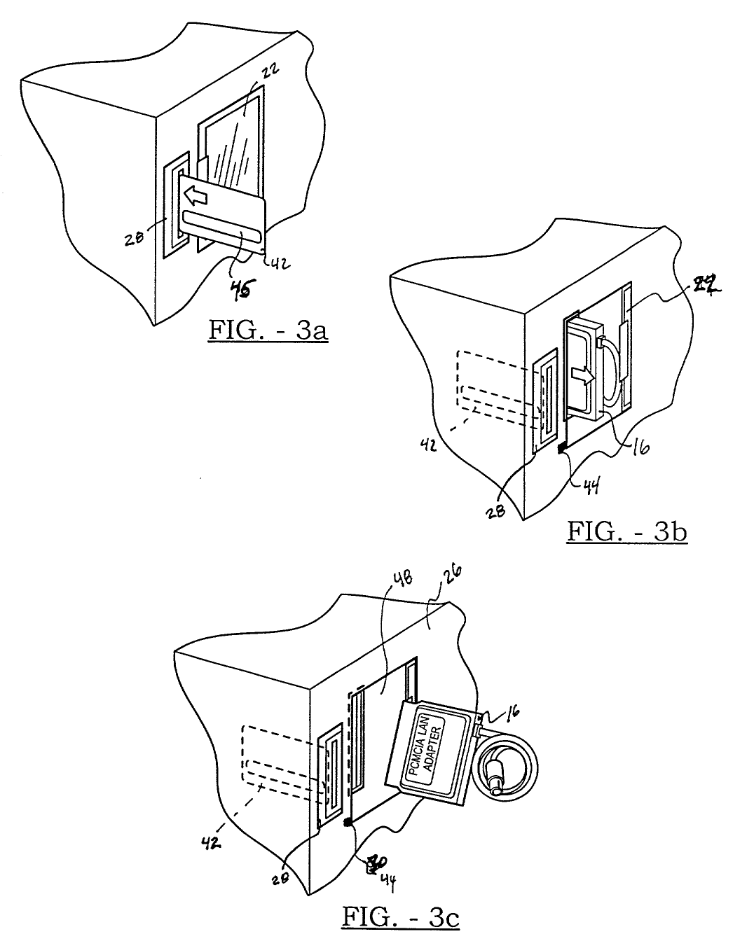

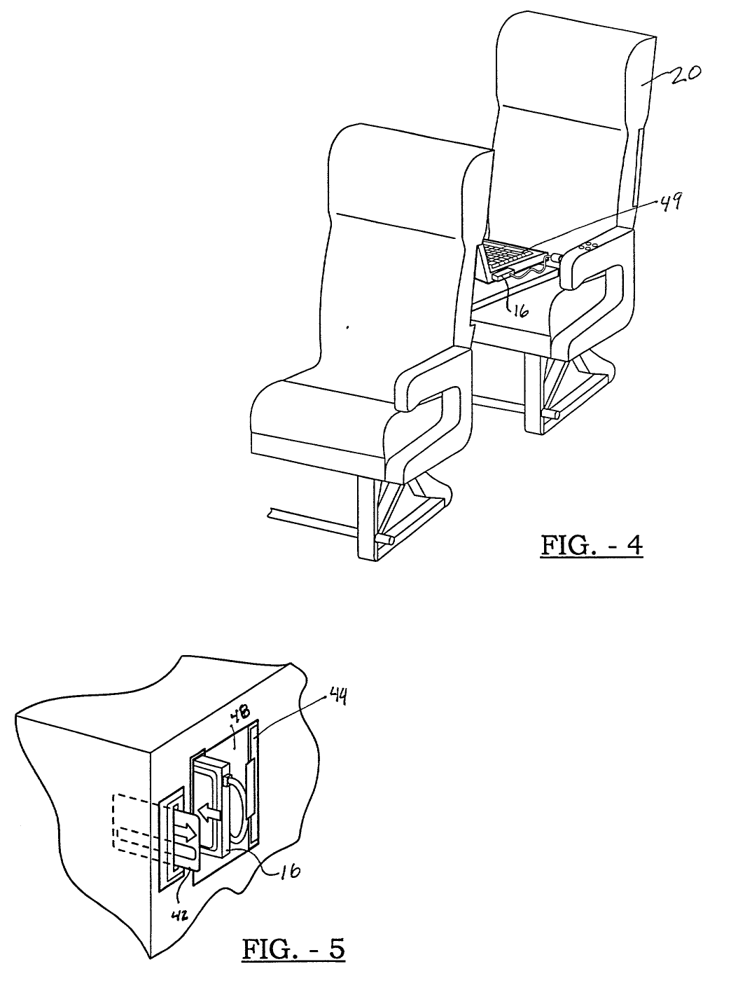

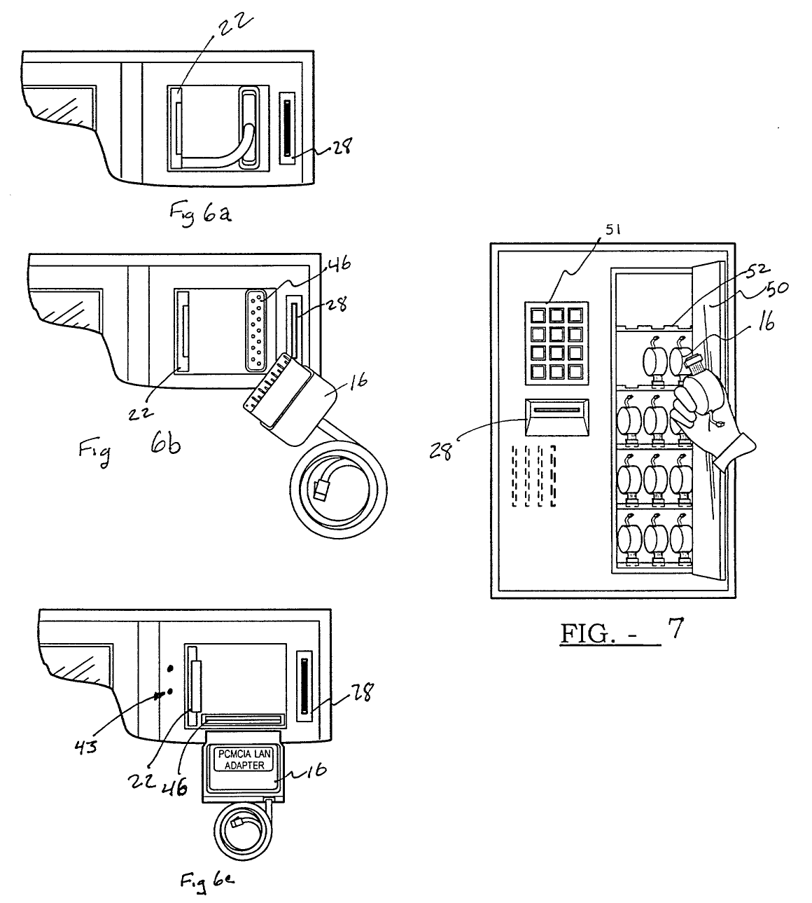

As best seen in FIG. 3a, a credit card 42 is inserted into the credit card acceptor 28. The credit card acceptor 28 can optionally have a key pad (see FIG. 7) to allow the input of passenger information such as name or seat number. Additionally, the credit card acceptor 28 has a magnetic strip reader (not shown) which reads account and identity information stored on the credit card magnetic strip 45. The credit card acceptor 28 has a locking mechanism (not shown) which locks the credit card 42 into the credit card acceptor 28 until the peripheral device 16 is returned.

FIGS. 3b and 3c depict the slidably mounted door 22 in its open position. Upon the approval of a processor unit (now shown) coupled to the credit card acceptor 28, a locking mechanism 44 is actuated which allows the door 22 to be opened. The passenger then can remove the peripheral device 16 from a cavity 48 formed in front of the peripheral distributor 10.

As can be seen in FIG. 4, the peripheral device 16 can be used to attach the passenger's computer 49 to an aircraft LAN 40. Once the passenger is finished with the peripheral device 16, it is inserted back into the cavity 48. Upon the detection of the peripheral device 16 by the processor, the credit card acceptor 28 releases the locking mechanism, freeing the credit card 42 to the passenger.

FIGS. 6a-6c represent an alternate embodiment to the present invention. Shown as a peripheral device 16 coupled to a connector 46. The coupling of the peripheral device 16 to the connector 46 allows a central processor (not shown) to determine whether the returned peripheral device 16 is functioning and the peripheral device 16 is the device borrowed. This determination can be made by checking an electronic signature, which is stored within the peripheral device 16. Further shown are optional red and green lights 43 which indicate whether the processor has released the locking mechanism 44 allowing the door 22 to be opened.

FIG. 7 depicts yet another embodiment of the present invention. Shown is a peripheral distributor 10 having a keypad 51 and a single door 50. A passenger would insert the credit card 42 into the credit card acceptor 28 to gain access to the peripheral devices 16 which are coupled to a locking support 52. In this embodiment, the credit card would either be immediately released or would be stored within the peripheral distributor 10. A processor (now shown) would determine when the peripheral device 16 is returned and charge the credit account a fee for use of the item. It is further envisioned the peripheral distributor 10 of the present invention can be used to distribute software drivers in disk or CD-rom formats.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for distributing peripheral devices within an aircraft comprising:
a front panel defining a cavity configured to hold said peripheral devices;
an openable door disposed over said cavity;
a locking device operably coupled to said openable door;
a credit card acceptor operably coupled to said locking device, whereby said locking device allows the opening of the door to retrieve a peripheral device upon insertion of credit card.

2. The device for distributing peripheral devices of claim 1 wherein said door is coupled to said front panel by a hinge.

3. The device for distributing peripheral devices of claim 1 wherein said door is slidably coupled to said front panel.

4. The device for distributing peripheral devices of claim 1 comprising a controller operably coupled to said credit card acceptor, whereby said controller accepts data taken by the credit card acceptor from the credit card.

5. The device for distributing peripheral devices of claim 1 wherein said peripheral device is selected from the group of cables, PCMIA card, CD-rom, and floppy disk.

6. The device for distributing peripheral devices of claim 4 further comprising a walking device operably coupled to said openable door in said processor.

7. The device for distributing peripheral devices of claim 1 further comprising a connector disposed within said cavity, wherein said peripheral device is coupled to said connector.

8. The device for distributing peripheral devices of claim 8 wherein said peripheral devices have an electronic signature.

9. An aircraft bulkhead comprising:
a device for distributing peripheral devices having a front panel defining a cavity configured to hold said peripheral devices;
an openable door disposed over said cavity;
a locking device operably coupled to said openable door; and
a credit card acceptor operably coupled to said locking device, whereby said locking device allows the opening of the door to retrieve a peripheral device upon insertion of a credit card.

10. The aircraft bulkhead of claim 9 further comprising a controller operably coupled to said credit card adapter and to said locking device.

11. The aircraft bulkhead of claim 10 further comprising a keypad operably coupled to said controller.

12. The aircraft bulkhead of claim 9 wherein said door is hingeably coupled to said front panel by a hinge.

13. The aircraft bulkhead of claim 9 wherein said door is slidably coupled to said front panel.

14. The aircraft bulkhead of claim 9 comprising a plurality of openable doors disposed over a plurality of cavities defined by said front panel.

15. The aircraft bulkhead of claim 10 further comprising a connector operably coupled to said controller, wherein said peripheral device is capable of being coupled to said connector.

16. The aircraft bulkhead of claim 10 further comprising at least one light coupled to said controller.
